(19) United States
(12) Patent Application Publication
(10) Pub. No.: US 2025/0258758 A1
(43) Pub. Date: Aug. 14, 2025

(54) AUTOMATION OF LOW-LEVEL TEST CREATION FOR SAFETY-CRITICAL EMBEDDED SOFTWARE

(71) Applicant: ANSYS, INC., Canonsburg, PA (US)

(72) Inventors: Bernard Andre Dion, Pittsburgh, PA (US); Jean-Louis Colaco, Escalquens (FR); John Carpenter Macauley, Jupiter, FL (US); Loic Wagner, Cugnaux (FR)

(21) Appl. No.: 19/192,015

(22) Filed: Apr. 28, 2025

Related U.S. Application Data
(63) Continuation of application No. PCT/US2023/019149, filed on Apr. 19, 2023.
(60) Provisional application No. 63/424,456, filed on Nov. 10, 2022.

(51) Int. Cl. G06F 11/3668

(52) U.S. Cl. CPC G06F 11/3684; G06F 11/3676; G06F 11/3688

(57) ABSTRACT

Low-level test cases for safety-critical applications are automatically created and executed. A set of low-level test cases for a software design model is created by using both a non-qualified test case creation tool and a qualified model coverage analysis tool. The created set of low-level test cases is verified to cover low-level requirements for the software model with respect to coverage criteria. A set of high-level test cases for the requirements above the software design model and the set of low-level test cases are executed on a target architecture, based on the source code generated from the software design model, using a qualified code generator. The set of high-level test cases and the set of low-level test cases achieve coverage of the source code as the qualified code generator preserves coverage from model to code.

### CROSS-REFERENCE TO RELATED APPLICATIONS

This application is a continuation of International Application No. PCT/US2023/019149, filed on Apr. 19, 2023, which claims priority to U.S. Provisional Application No. 63/424,456, filed Nov. 10, 2022. All of the aforementioned applications are hereby incorporated herein by reference in their entireties and for all purposes.

### TECHNICAL FIELD

Embodiments relate to automating the creation and execution of low-level test cases for safety-critical applications.

### BACKGROUND

Verification activities constitute a major part of the costs in developing and certifying a safety-critical application.

Conventional verification typically involves the deployment of a large number of software developers manually writing tests. Safety-critical software can require the use of “qualified” software tools for achieving development and verification activities. A qualified tool, as established by a working group in charge of creating standards, per a safety standard, e.g., DO-178C and DO-330 for aeronautics, can be adopted as “an acceptable means of compliance” for airborne software certification. Such a qualified tool is one that can be relied upon to produce appropriate and repeatable results, and importantly, does not require additional testing and verification of its outputs.

### SUMMARY

An embodiment of the disclosure is based on the following two aspects that allow full automation of the creation and execution of low-level test cases:

In conjunction with the creation of low-level test cases at a software design model-level, the combined use of a non-qualified test case creation tool and a qualified model coverage analysis tool to verify that the so-created test cases appropriately cover the low-level requirements per the expected coverage criteria.

While executing high-level test cases and the above-described low-level test cases on the target architecture, using a qualified automatic code generator that preserves the Modified Condition/Decision Coverage (MC/DC) coverage properties from model to code level, so that no other activity is needed beyond verifying that expected test case results are achieved on the target architecture.

### BRIEF DESCRIPTION OF THE DRAWINGS

Various techniques will be described with reference to the drawings, in which:

FIG. 1 is a flow diagram of an example method of producing executable code from a software design model, in accordance with the present disclosure.

FIG. 2 is a block diagram of an example model-based development and verification requirements architecture, in accordance with the present disclosure.

FIG. 3A is a flow diagram of an example model-based development and verification process, in accordance with the present disclosure.

FIG. 3B is a flow diagram of an example model-based development and verification process, in accordance with the present disclosure.

FIG. 4 is a flow diagram of an example model-based development and verification process, in accordance with the present disclosure.

FIG. 5 is a flow diagram of an example model-based development and verification process, in accordance with the present disclosure.

FIG. 6 is a block diagram that illustrates an example architecture for the automation of low-level test creation for safety-critical embedded software, in accordance with the present disclosure.

FIG. 7 is a block diagram that illustrates an example architecture for the automation of low-level test creation for safety-critical embedded software, in accordance with the present disclosure.

FIG. 8 is a block diagram that illustrates an example architecture for the automation of low-level test creation for safety-critical embedded software, in accordance with the present disclosure.

FIG. 9 is a block diagram of an example computing device that may perform one or more of the operations described herein, in accordance with the present disclosure.

### DETAILED DESCRIPTION

As described in more detail below, embodiments of tools are described for automating testing activities to minimize human intervention. Upon creation of a software design model along with high- and low-level tests, verification software can evaluate the model for test coverage and identify test coverage gaps. Additional tests can be generated to fill the test coverage gaps and upon a determination of successful test coverage, source code can be generated from the model. The source code can then be compiled to produce executable code for a target processor architecture.

Embodiments of the present disclosure employ a non-qualified tool, rather than a qualified tool, to generate tests that satisfy test coverage gaps. By subsequently using a qualified tool to verify resolution of the test coverage gaps, the resulting software can satisfy the appropriate quality requirements. In short, software tests generated by a non-qualified tool can be validated by a qualified tool.

As a result, an improvement to the production of safety-critical software can be realized through the use of a non-conventional operation. Embodiments of the disclosure are necessarily rooted in computer software technology and overcome the challenges of using a qualified tool to resolve test coverage gaps for safety-critical software.

The purpose of a tool qualification process is to obtain confidence in tool functionality. A tool qualification effort varies based upon the potential impact that a tool error could have on system safety and upon the overall use of the tool in the software life cycle process. Tool qualification is required whenever the design assurance process(es) described in DO-178C are eliminated, reduced, or automated by the use of the tool unless the output of the tool is verified. See DO-178C section 12.2.1. The higher the risk of a tool error adversely affecting system safety, the higher the rigor required for tool qualification. Tool qualification comprises five Tool Qualification Levels: TQL-1 to TQL-5. The determination of the appropriate tool qualification level, TQL-1 to TQL-5, is achieved by an assessment of the tool use in the software life cycle. See DO-178C section 12.2.2. TQL-1 is the most demanding level and requires well defined and executed tool development, verification, and integral processes with the highest degree of verification independence.

As described in DO-330, tool qualification processes can include, but are not limited to, determining that tool requirements are accurate and consistent, that the tool source code complies with low-level tool requirements, that the tool source code is verifiable, that the tool executable object code complies with tool requirements, that test coverage of tool requirements is achieved, that test coverage of low-level tool requirements is achieved, and that analysis of requirements-based testing of external components is achieved. See DO-330 Tables T0-T10 for a complete description of which objectives apply at which level, TQL-1 to TQL-5.

Flight hardware, software, and systems are “certified.” However, tools are used in development and/or verification and the tool itself doesn't normally fly or execute onboard the aircraft during flight. However, reliance is being placed on the tool to provide evidence and output that meet certification objectives, therefore confidence must be established to prove the tool provides at least the equivalent assurance of the certification process(es) which is/are eliminated, reduced, or automated. The dependability of the tool being used must be established. Establishing the dependability of the tool and building the confidence that the tool provides at least the equivalent design assurance process for the level required is accomplished by the tool qualification process. The first step of which is to establish whether a tool needs to be qualified, by an applicant, e.g., an aircraft or engine manufacturer, using safety standards such as DO-178C and DO-330. If the output of a tool is not verified, the tool needs to be qualified.

A software development process can include software requirements definition, software design, software coding, and integration with a target computer. Embodiments of the present disclosure automate the creation and execution of low-level test cases for safety-critical applications. Some cases cover the application embedded software source code for the most critical applications—e.g., MC/DC. MC/DC is a code coverage criterion used in software testing. Code coverage is a way of measuring the effectiveness of test cases. The higher the percentage of code that has been covered by testing, the less likely it is to contain bugs when compared to code that has been tested with a lower coverage score. MC/DC requires that each condition in a decision can be shown to independently affect that decision's outcome. A condition can be shown to independently affect a decision's outcome by varying just that condition while holding all other possible conditions fixed. In summary, MC/DC coverage is achieved if: (1) each entry and exit point is invoked; (2) each decision takes every possible outcome; (3) each condition in a decision takes every possible outcome; (4) each condition in a decision is shown to independently affect the outcome of the decision.

Model coverage helps verify a model by analyzing the behavior of covered objects, states, and transitions, and measuring the extent to which a simulation exercises the potential simulation pathways through each covered object in the model. While code coverage is a measure of how much code is executed during testing, model coverage is a measure of how much of the feature set of the model is exercised by the tests.

The present disclosure achieves these source code coverage objectives with qualified tools, through the use of a code generator that preserves MC/DC coverage from initial design activities within the software design model (SDM) to generation of the source code. Generally, the output of a qualified tool can be trusted to perform as specified, across a specified range of inputs, and does not require subsequent verification of its outputs. By contrast, the verification of the output of a non-qualified tool can require extensive review, analysis, or testing that can significantly increase time and budget requirements.

Some cases can be trusted in accordance with the regulations applicable to safety critical embedded software and to the software tools that are used to develop it, at the highest level of safety—e.g., Level A for DO-178C in aeronautics. Certification of safety-critical software applications is regulated by safety standards that are mandated by law (US Congress, EU Parliament, etc.) and vary by the industrial domain. Software applications can be assigned a Design Assurance Level—e.g., Level A software applications consider (catastrophic) failure conditions that would result in the loss of the airplane with multiple fatalities. Any software that is critical to provide (or prevent failure of) continued safe flight and landing of an aircraft is defined as being Level A software. Any aerospace software that is being created at this level of assurance must measure and report MC/DC coverage.

In aeronautics, international software standards—e.g., published via https://www.rtca.org/standards/, Dec. 13, 2011—prepared by SC-205, include: (1) DO-178C: Software Considerations in Airborne Systems and Equipment Certification, European Organization for Civil Aviation Equipment (EUROCAE) and Radio Technical Commission for Aeronautics (RTCA); (2) DO-331: Model-based Development and Verification Supplement to DO-178C and DO-278A, EUROCAE and RTCA, when Model-Based Development and Verification (MBDV) is used; and (3) DO-330: Software Tool Qualification Consideration, EUROCAE and RTCA. Similar standards exist in the rail, automotive, and nuclear industries. DO-178 was originally developed in the late 1970s to define a prescriptive set of design assurance processes for airborne software that focused on documentation and testing. In the 1980s, DO-178 was updated to DO-178A, which suggested different levels of activities dependent on the criticality of the software, but the process remained prescriptive. Released in 1992, DO-178B was a total re-write of DO-178 to move away from the prescriptive process approach and define a set of activities and associated objectives that a design assurance process must meet. In 2012, DO-178C/ED-12C was released, which clarified details and removed inconsistencies from DO-178B, and which also includes supplements that provide guidance for design assurance when specific technologies are used, supporting a more consistent approach to compliance for software developers using these technologies. DO-178C guidance also clarified some details within DO-178B so that the original intent could be better understood and more accurately met by developers.

Development activities requirements under the standards—e.g., DO-178C Section 11/DO-331, Section MB.11—can include production of the following life cycle data: (1) High-Level Requirements (HLR) s—i.e., the software specification; (2) Low-Level Requirements (LLR) s—i.e., the software detailed design, which takes the form of an SDM when MBDV is used [DO-331]; (3) source code that may automatically be generated from the SDM [DO-331/DO-330]; and (4) Executable Object Code produced for the target computer. Per DO-178C, Section 12.2, each artifact needs to be verified unless it is produced by a qualified tool.

An SDM prescribes software component internal data structures, data flow, and/or control flow. An SDM includes low-level requirements and/or architecture. In particular, when a model expresses software design data, it should be classified as a design model. In some cases, an SDM is developed from high-level requirements. Low-level requirements may be included in an SDM.

Verification activities requirements under the standards can include creating both HLR-based test cases and LLR-based test cases. See DO-178C, Section 6. HLR-based test cases may cover the SDM (SDM/LLRs) with a less stringent coverage criteria (e.g., DC-Decision Coverage) through model simulation and should produce expected results when MBDV simulation is used. See DO-331, Section 6.8. The combination of HLR- and LLR-based test cases should cover the source code with a more stringent coverage criteria (MC/DC-Modified Condition/Decision Coverage). See DO-178C, Table A-7, Objective 5. The combination of HLR- and LLR-based test cases as applied against the source code should provide equivalence class coverage (e.g., data ranges, include test cases close to minimum, close to maximum, and middle, etc.) See DO-178C, Section 6.4.4.2. Equivalence class testing is a software testing technique that divides the input domain of values of the application under test into partitions, each partition being composed of values considered equivalent for the application. The test strategy pursues having at least one test that falls in each identified partition. An advantage of equivalence class testing is that it can reduce the time and effort required for testing software by identifying the relevant input values to consider and thus reducing the number of test cases. HLR- and LLR-based tests should produce expected results when they run on the target. See DO-178C, Section 6.

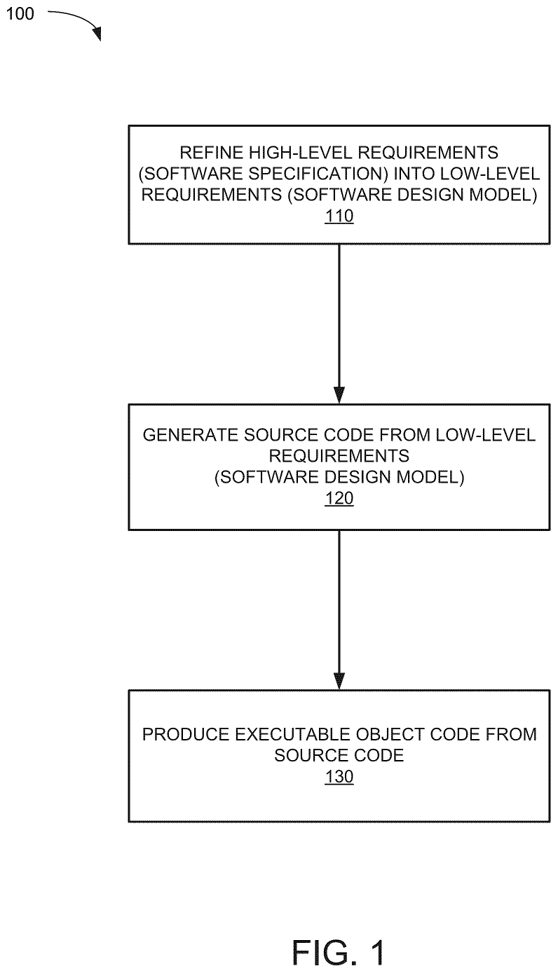

FIG. 1 is a flow diagram of an example method 100 of producing executable code from a software design model, in accordance with embodiments of the disclosure. Method 100 illustrates an example extract of development activity requirements. Method 100 may be performed by processing logic that may comprise (1) hardware—e.g., circuitry, dedicated logic, programmable logic, a processor, a processing device, a central processing unit (CPU), a system-on-a-chip (SoC), etc.—and (2) software—e.g., instructions running/executing on a processing device, firmware, e.g., microcode, or a combination thereof.

With reference to FIG. 1, method 100 illustrates example functions used by various embodiments. Although specific function blocks (“blocks”) are disclosed in method 100, such blocks are examples. That is, examples are well suited to performing various other blocks or variations of the blocks recited in method 100. It is appreciated that the blocks in method 100 may be performed in an order different than presented, and that not all of the blocks in method 100 may be performed.

Method 100 begins at block 110, where the processing logic causes high-level requirements captured in a software specification to be refined into low-level requirements that are maintained in a software design model. In some cases, high-level tests are developed along with the software design model. The software design model may be updated as a result of simulating the SDM to measure the DC coverage. Simulation may reveal errors that require the SDM to be updated. After creating data ranges and observer specifications for the equivalence classes, the SDM can be measured for MC/DC and equivalence class coverage. Identified coverage gaps can be addressed by generating low-level tests to cover the gaps. After confirming that the low-level tests appropriately contribute to resolving the coverage gaps, and verifying MC/DC and equivalence class SDM coverage, a coverage report may be produced.

At block 120, the processing logic generates source code from the low-level requirements in the software design model.

At block 130, the processing logic produces executable object code from the source code. In some cases, this executable object code is specific to a computer processor or architecture—e.g., a target. In some cases, the processing logic executes high-level and low-level tests against the target to verify functionality.

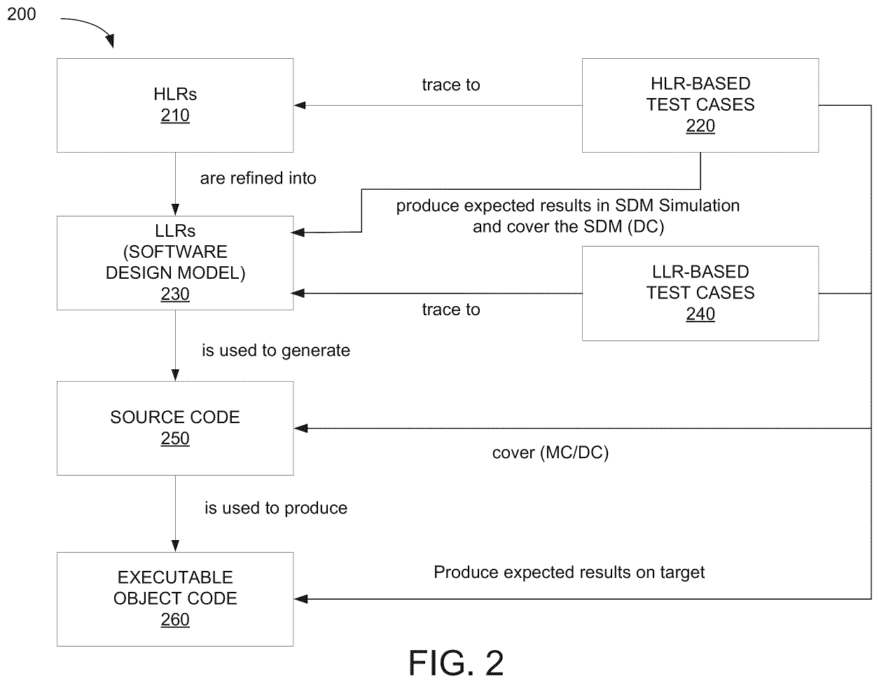

FIG. 2 is a block diagram of an embodiment of a model-based development and verification requirements architecture, in accordance with the present disclosure. In the example, high-level requirements (HLRs) 210 are identified and refined into low-level requirements, the software detailed design, within a software design model 230. HLR-based test cases 220 are developed along with the HLRs 210. There should be traceability between the HLR-based test cases and the HLRs. Decision Coverage (DC) of the SDM can then be confirmed by the HLR-based test cases.

Traceability between low-level-based test cases (LLR-based test cases) and the software design model 230 is also recorded and maintained. The combination of HLR- and LLR-based test cases should provide Modified Condition/Decision Coverage (MC/DC) against the source code. A qualified SDM coverage measurement tool is used to analyze SDM coverage for MC/DC and equivalence class coverage to identify any coverage gaps. In some cases, an updated SDM Coverage Report and identified MC/DC and equivalence class coverage gaps are produced. In some cases, a qualified SDM coverage measurement tool consumes the updated SDM and the HLR- and LLR-based test cases, verifies MC/DC and equivalence class coverage of the SDM using the combined HLR- and LLR-based test cases, and produces an SDM Coverage Report (MC/DC and equivalence class coverage).

The software design model is used to generate source code 250. In some cases, a qualified code generation tool uses the SDM to generate source code implementing the SDM that can be subsequently compiled into executable object code for a target architecture. In some cases, the use of a qualified tool provides a guarantee that MC/DC model coverage is preserved at the source code level when test cases are executed on the target, without an additional requirement to measure that coverage.

In some cases, the processing logic compiles the source code 250 to produce executable object code 260 for a designated target computer or architecture. In some cases, a qualified tool consumes the executable object code and the HLR- and LLR-based test cases and executes the HLR- and LLR-based test cases on the target architecture. In some cases, the qualified tool produces a Pass/Fail Report for the HLR- and LLR-based tests.

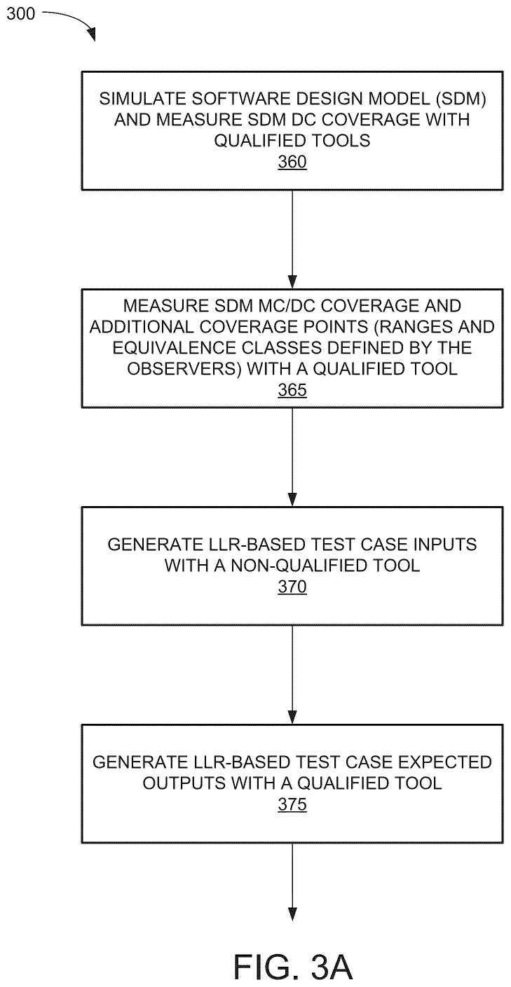

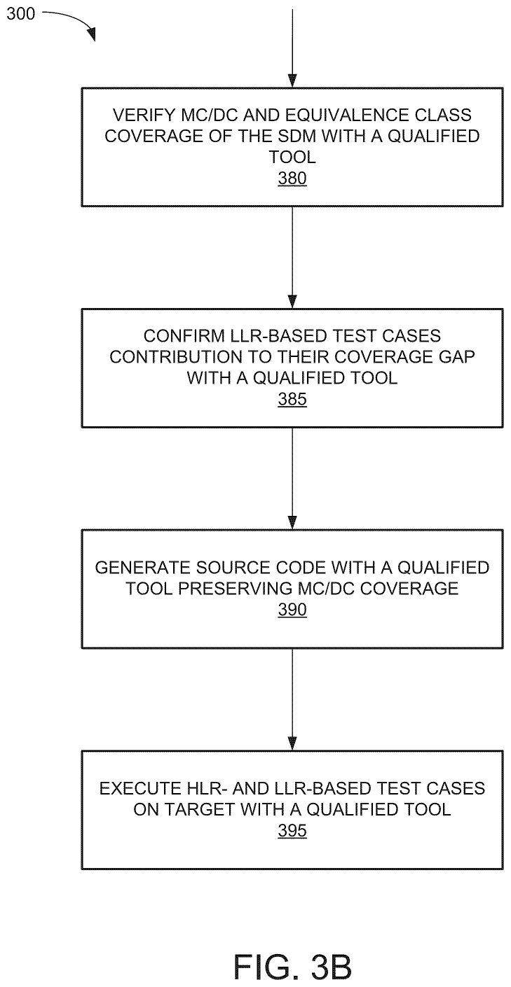

FIGS. 3A and 3B illustrate Solution Steps 1 through 8 of an embodiment. FIG. 3A is a flow diagram of an example model-based development and verification process 300, in accordance with the present disclosure. FIG. 3A begins with Solution Step 1, “Simulate Software Design Model (SDM) and Measure SDM DC Coverage with Qualified Tools,” step 360. For Solution Step 1, high-level requirements are used as inputs to create a software design model (SDM) and to create high-level requirements-based tests. For some embodiments, creation of the SDM is not automated and thus is external to the process. For some embodiments, creation of the HLR tests is not automated and thus is external to the process. Thus, for some embodiments, HLRs, HLR-based test cases, and the SDM are manually created and reviewed. The HLRs, HLR-based test cases, and the SDM are then exercised with a qualified Design Model Simulation tool to generate a Pass/Fail Report. In some cases, a qualified SDM Coverage measurement tool can analyze the DC coverage of the HLR-based test cases against the SDM. Iterative updates can be made to the HLRs, HLR-based test cases, and SDM to resolve DC coverage gaps. Using feedback from the qualified Design Model Simulation tool, an updated SDM, updated HLRs, updated HLR-based test cases, and an SDM Coverage Report can be produced. In some embodiments, Solution Step 1 is controlled by regulatory requirements DO-178C and DO-331, Section 6.8.

Step 365 comprises Solution Step 2, “Measure SDM MC/DC Coverage and Additional Coverage Points (Ranges and Equivalence Classes Defined by the Observers) with a Qualified Tool.” An Observer is an additional part of a model that observes its simulation and detects if some conditions have been met. For example, “was there a test in which the value of A was greater than 10?” For some embodiments, the creation of data ranges is external to the process. Once ranges are available, Observers can be added to the SDM. While not changing the outputs of SDM simulation or coverage analysis on the basis of the HLR-based test cases, the Observers can be used by the qualified coverage measurement tool to determine Equivalence Class Coverage gaps. Using the updated SDM, the updated HLR-based tests, the data ranges, and observer specifications for equivalence classes, a qualified processing tool measures SDM MC/DC coverage, that may be defined as an extension of MC/DC code coverage at the model level, and additional points (namely, the ranges and the equivalence classes defined by the observers) to detect coverage gaps. In some cases, the updated SDM, the updated HLR-based test cases, data ranges, and observer specifications for equivalence classes can then be used to produce an updated SDM Coverage Report. In some embodiments, Solution Step 2 is controlled by regulatory requirements DO-178C, Table A-7, Objective 5; DO-178C, Section 6.4.4.2; and DO-331, Section 6.8.

Step 370 comprises Solution Step 3, “Generate LLR-Based Test Case Inputs with a Non-Qualified Tool,” in which the output of element 365, Solution Step 2, is consumed by a non-qualified SDM Coverage Assistant tool to use the updated SDM and the identified MC/DC and equivalence class coverage gaps to generate LLR test inputs to cover these gaps. LLR-based test case inputs are generated to cover each gap. In some embodiments, Solution Step 3 is controlled by regulatory requirements DO-178C, Section 6; DO-178C, Table A-7, Objective 5; DO-178C, Section 6.4.4.2; and DO-331.

Step 375 comprises Solution Step 4, “Generate LLR-Based Test Case Expected Outputs with a Qualified Tool,” in which a qualified Software Design Model Simulation tool consumes the updated SDM and the LLR-based test case inputs and generates expected outputs for the extended set of LLR-based test cases. Significantly, the use of a non-qualified tool is followed by the use of a qualified tool as part of the LLR test preparation. Software test creation by a non-qualified tool is part of a process that involves validation by qualified tools, which allows for increased automation of the development of a safety-critical application. In some embodiments, Solution Step 4 is controlled by regulatory requirements DO-331 and DO-178C, Section 6.

FIG. 3B is a continuation of the flow diagram FIG. 3A of an example model-based development and verification process 300, in accordance with the present disclosure. FIG. 3B continues with Solution Step 5, element 380, “Verify MC/DC and Equivalence Class Coverage of the SDM with a Qualified Tool.”

For Solution Step 5, a qualified SDM Coverage Measurement Tool consumes the updated SDM, the updated HLR-based test cases, and the LLR-based test cases. The qualified SDM Coverage Measurement Tool verifies MC/DC and Equivalence Class coverage of the Updated SDM using the combined HLR-based and LLR-based test cases. The qualified SDM Coverage Measurement Tool produces an SDM Coverage Report (MC/DC). In some embodiments, Solution Step 5 is controlled by regulatory requirements DO-331, DO-178C, Section 6, DO-178C, Table A-7, Objective 5, and DO-178C, Section 6.4.4.2.

Step 385 comprises Solution Step 6, “Confirm LLR-Based Test Cases Contribution to their Coverage Gap with a Qualified Tool,” in which a qualified confirmation tool consumes the LLR-based test cases and the SDM Coverage Report (MC/DC). The qualified confirmation tool confirms the coverage contribution of each LLR-based test case corresponding to a coverage gap. In some cases, this tool establishes that the coverage contribution is not the result of a side effect associated with another test case. In some cases, the tool produces a confirmation that the LLR-based test cases have been properly generated according to the appropriate safety standard—e.g., DO-178C. In some embodiments, Solution Step 6 is controlled by regulatory requirements DO-178C, Section 6, DO-178C, Table A-7, Objective 5, and DO-178C, Section 6.4.4.2.

Step 390 comprises Solution Step 7, “Generate Source Code with a Qualified Tool Preserving MC/DC Coverage,” in which a qualified Code Generation tool uses the updated SDM to generate source code, while preserving MC/DC coverage from SDM to code, that can be subsequently compiled into executable object code for a target architecture. Significantly, the use of such a qualified tool provides a guarantee that MC/DC model coverage is preserved at the source code level when test cases are executed on the target architecture, without an additional requirement to measure that coverage. In some embodiments, Solution Step 7 is controlled by regulatory requirements DO-330 and DO-331.

Step 395 comprises Solution Step 8, “Execute HLR- and LLR-Based Test Cases on Target with a Qualified Tool,” in which a qualified tool can consume executable object code that has been compiled from the source code, the updated HLR-based test cases, and LLR-based test cases, and execute the updated HLR-based test cases and LLR-based test cases on the target architecture. In some cases, the qualified tool produces a Pass/Fail Report for the updated HLR-based tests and LLR-based tests. In some embodiments, Solution Step 8 is controlled by regulatory requirements DO-331/DO-330; DO-178C, Table A-7, Objective 5; and DO-178C Section 6, including 6.4.4.2.

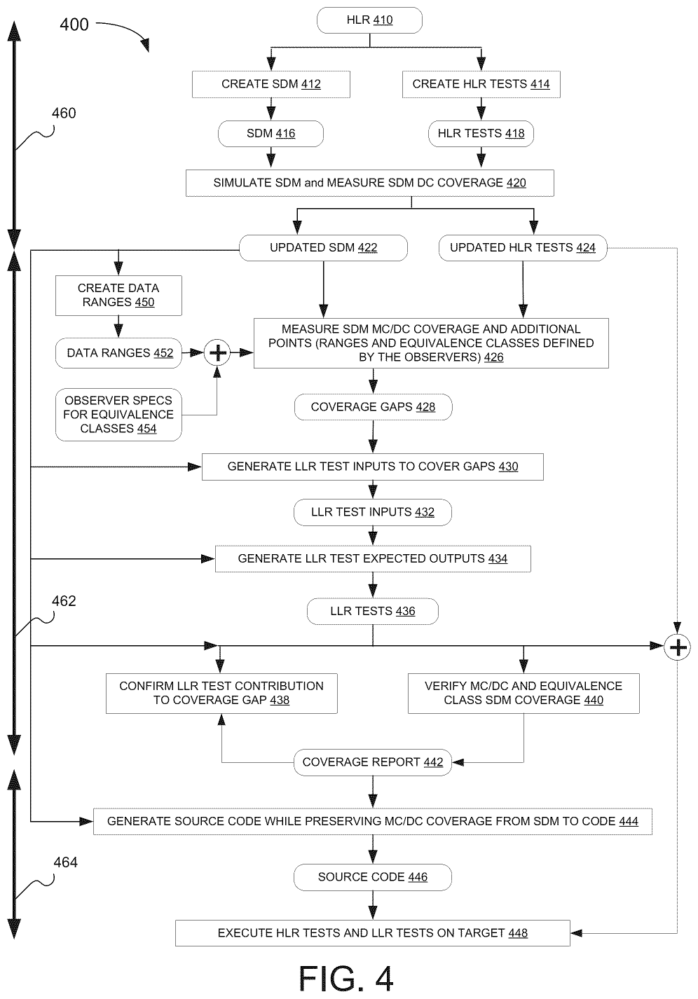

FIG. 4 is a flow diagram of an embodiment of a model-based development and verification process 400, in accordance with the present disclosure. In some embodiments, process 400 is equivalent to process 300 of FIGS. 3A and 3B. Process 400 can, for example, be used for the development of a safety-critical application. Operations and data encompassing 460 involve HLR test preparation. Operations and data encompassing 462 involve LLR test preparation. Operations and data encompassing 464 involve test execution. Note that elements of FIG. 4 with square corners represent processes and those with rounded corners represent data.

In FIG. 4, boxes 410, 416, 418, 422, 424, 452, 454, 428, 432, 436, 442, and 446 represent respective data. Boxes 420, 426, 434, 438, 440, 444, and 448 represent respective qualified algorithmic tools. Box 430 represents a non-qualified algorithmic tool.

In FIG. 4, respective operations and data can be further grouped into respective Solution Steps 1 through 8 to aid understanding. In FIG. 4, for Solution Step 1 (i.e., step 360 from FIG. 3A), high-level requirements 410 are used as inputs at box 412 to create a software design model (SDM) 416 and as inputs at box 414 to create high-level requirements-based tests 418. For some embodiments, step 412 of the creation of the SDM is not automated and thus is external to the process. For some embodiments, the step 414 of the creation of the HLR tests is not automated and thus is external to the process. Thus, for some embodiments, HLRs 410, HLR-based test cases 418, and the SDM 416 are manually created and reviewed. The HLRs 410, HLR-based test cases 418, and the SDM 416 are then exercised with a qualified Design Model Simulation tool 420 to generate a Pass/Fail Report. In some cases, a qualified SDM Coverage measurement tool 420 can analyze the DC coverage of the HLR-based test cases 418 against the SDM 416. Iterative updates can be made to the HLRs 410, HLR-based test cases 414, and SDM 416 to resolve DC coverage gaps. Using feedback from the qualified Design Model Simulation tool 420, an updated SDM 422, updated HLRs, updated HLR-based test cases 424, and an SDM Coverage Report can be produced. Solution Step 1 is shown at a high-level as element 360 in FIG. 3A. In some embodiments, Solution Step 1 is controlled by regulatory requirements DO-331, including Section 6.8.

For Solution Step 2 (i.e., step 365 from FIG. 3A), the updated SDM 422 shown in FIG. 4 is used to create 450 data ranges 452. For some embodiments, step 450 involving the creation of data ranges is external to the process. Using the updated SDM 422, the updated HLR-based tests 424, the data ranges 452, and observer specifications for equivalence classes 454, a qualified processing tool 426 measures SDM MC/DC coverage and additional points (namely, the ranges 452 and the equivalence classes 454 defined by the observers) to produce coverage gaps 428. In some cases, the updated SDM 422, the updated HLR-based test cases 424, data ranges 450, and observer specifications for equivalence classes 454 can then be used to produce an updated SDM Coverage Report. Solution Step 2 is shown at a high-level as element 365 in FIG. 3A. In some embodiments, Solution Step 2 is controlled by regulatory requirements DO-178C, Table A-7, Objective 5; DO-178C, Section 6.4.4.2; and DO-331, including Section 6.8.

For Solution Step 3 (i.e., step 370 from FIG. 3A), a non-qualified SDM Coverage Assistant tool 430, as shown in FIG. 4, can use the updated SDM 422 and the identified MC/DC and equivalence class coverage gaps 428 to generate LLR test inputs to cover gaps. LLR-based test case inputs are generated at 430 to cover each gap and a trace is added from each gap to a corresponding test case. In some cases, identified MC/DC and equivalence class coverage gaps are produced. Solution Step 3 is shown at a high-level as element 370 in FIG. 3A. In some embodiments, Solution Step 3 is controlled by regulatory requirements DO-331, DO-178C, Section 6, DO-178C, Table A-7, Objective 5, and DO-178C, Section 6.4.4.2.

For Solution Step 4 (i.e., step 375 from FIG. 3A), a qualified Software Design Model Simulation tool 434 can consume the updated SDM and the LLR-based test case inputs 432 and generate expected outputs 436 for the extended set of LLR-based test cases 436. Significantly, the use of a non-qualified tool 430 is followed by the use of a qualified tool 434 as part of the LLR test preparation. For process 400, software test creation by non-qualified tool 430 is part of a process that involves validation by qualified tools, which allows for increased automation of the development of a safety-critical application. Solution Step 4 is shown at a high-level as element 375 in FIG. 3A. In some embodiments, Solution Step 4 is controlled by regulatory requirements DO-331 and DO-178C, Section 6.

For Solution Step 5 (i.e., step 380 from FIG. 3B), the updated SDM 422, the updated HLR-based test cases 424, and the LLR-based test cases 436 are propagated along flow 462 as illustrated in FIG. 4, to be ultimately consumed by a qualified SDM Coverage Measurement Tool 440. The qualified SDM Coverage Measurement Tool 440 verifies MC/DC and Equivalence Class coverage of the Updated SDM 422 using the combined HLR-based 424 and LLR-based 436 test cases. The qualified SDM Coverage Measurement Tool 440 produces an SDM Coverage Report (MC/DC) 442. Solution Step 5 is shown at a high-level as element 380 in FIG. 3B. In some embodiments, Solution Step 5 is controlled by regulatory requirements DO-331, DO-178C, Section 6, DO-178C, Table A-7, Objective 5, and DO-178C, Section 6.4.4.2.

For Solution Step 6 (i.e., step 385 from FIG. 3B), a qualified confirmation tool 438 of FIG. 4 can consume the LLR-based test cases and the SDM Coverage Report (MC/DC) 442 (which is an output from the qualified tool 440). The qualified confirmation tool 438 confirms the coverage contribution of each LLR-based test case (from input 436) corresponding to a coverage gap. In some cases, this tool 438 establishes that the coverage contribution is not the result of a side effect associated with another test case. In some cases, the tool 438 produces a confirmation that the LLR-based test cases 436 have been properly generated according to the appropriate safety standard—e.g., DO-178C. Solution Step 6 is shown at a high-level as element 385 in FIG. 3B. In some embodiments, Solution Step 6 is controlled by regulatory requirements DO-178C, Section 6, DO-178C, Table A-7, Objective 5, and DO-178C, Section 6.4.4.2.

For Solution Step 7 (i.e., step 390 from FIG. 3B), a qualified Code Generation tool 444 can use the updated SDM 422 to generate source code 446, while preserving MC/DC coverage from SDM to code, that can be subsequently compiled into executable object code for a target architecture. Significantly, the use of a qualified tool 444 provides a guarantee that MC/DC model coverage is preserved at the source code level when test cases are executed on the target architecture, without an additional requirement to measure that coverage. Solution Step 7 is shown at a high-level as element 390 in FIG. 3B. In some embodiments, Solution Step 7 is controlled by regulatory requirements DO-331 and DO-330.

For Solution Step 8 (i.e., step 395 from FIG. 3B), a qualified tool 448 can consume executable object code that has been compiled from the source code 446, the updated HLR-based test cases 424, and LLR-based test cases 436, and execute the updated HLR-based test cases 424 and LLR-based test cases 436 on the target architecture. In some cases, the qualified tool 448 produces a Pass/Fail Report for the updated HLR-based tests 424 and LLR-based tests 436. Solution Step 8 is shown at a high-level as element 395 in FIG. 3B. In some embodiments, Solution Step 8 is controlled by regulatory requirements DO-178C, Table A-7, Objective 5; DO-178C, including Sections 6 and 6.4.4.2; and DO-330.

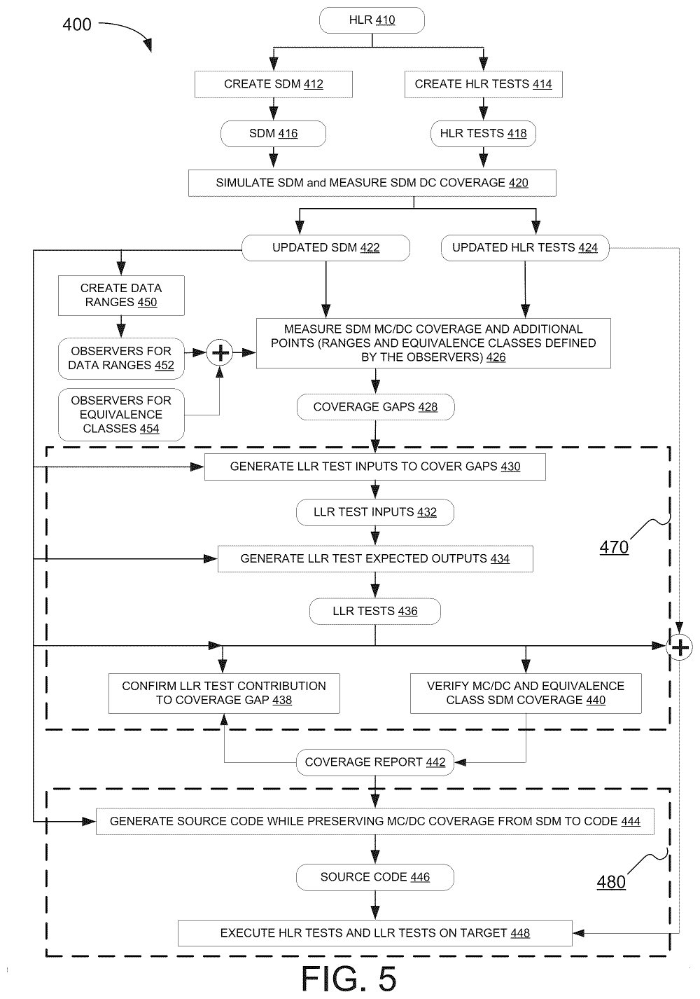

FIG. 5 is a block diagram of an example model-based development and verification process 400, in accordance with the present disclosure. FIG. 5 adds to FIG. 4 by illustrating box 470, which includes elements 430-440, which comprise creating a set of low-level test cases for a software design model by using a non-qualified test case creation tool and a qualified model coverage analysis tool. In some cases, the created set of low-level test cases are verified to cover low-level requirements for the software model with respect to coverage criteria. Note that elements of FIG. 5 with square corners represent processes and those with rounded corners represent data.

Box 480 includes elements 444-448, which comprise executing a set of high-level test cases and a set of low-level test cases for a software design model on a target architecture, the set of high-level test cases and the set of low-level test cases being executed based on code generated using a qualified code generator, coverage of the set of high-level test cases and the set of low-level test cases verified for the software model being preserved for the code generated by the qualified code generator.

The methods and systems described herein not only provide the practical application of automating the creation and execution of low-level test cases for safety-critical aeronautical embedded software, but for railway-, automotive-, and nuclear-directed embedded software. Safety-critical railway software is required to comply with EN 50128 as published by the European Committee for Electrotechnical Standardization (CENELEC). EN 50128 is a generally accepted European standard that regulates the development, distribution, and maintenance of safety-related software in all railway applications. The areas covered by EN 50128 include the life cycle and software assurance. Automatic testing in EN 50128 can reduce the time to find and eliminate an existing problem. The International Electrotechnical Commission (IEC) 62279 is another standard for developing software used in railway control systems where safety is a concern. This standard provides guidance on the process and necessary technical requirements to ensure safety critical software meets industry expectations.

Embedded safety-critical software in the automotive industry is required to comply with International Standards Organization (ISO) 26262, an automotive safety standard created for electrical/electronic that serve safety applications in automobiles. ISO 26262 provides guidelines to suppliers, OEMs, and semiconductor companies to create a safe product that can be used in the cars.

Embedded safety-critical software in the nuclear industry is required to comply with IEC 60880.

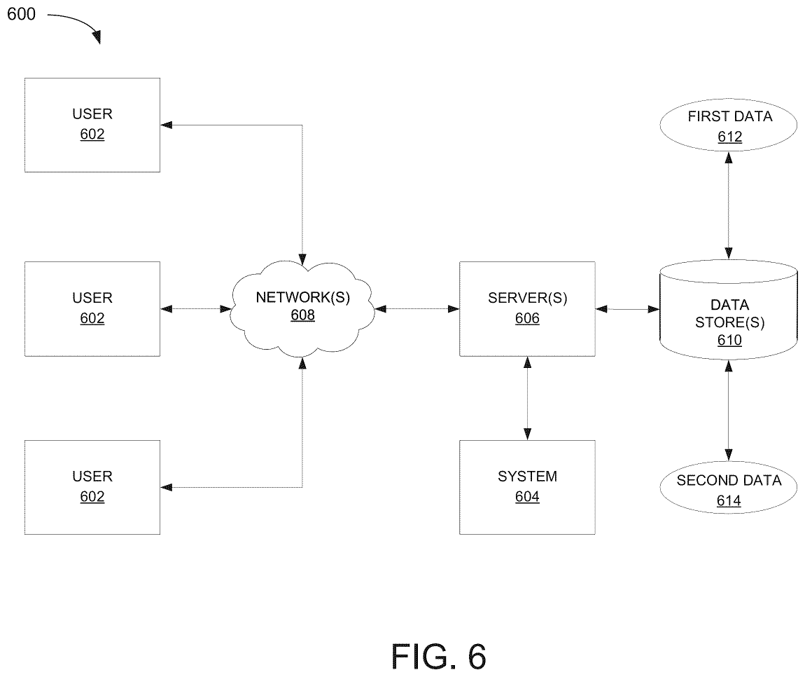

The methods and systems described herein may be implemented using any suitable processing system with any suitable combination of hardware, software and/or firmware, such as described below with reference to the non-limiting examples of FIGS. 6, 7, 8, and 9.

FIG. 6 is a block diagram that illustrates an example architecture 600 for the automation of low-level test creation for safety-critical embedded software, in accordance with the present disclosure. The architecture 600 of FIG. 6 depicts an example computer-implemented environment wherein users 602 can interact with a system 604 hosted on one or more servers 606 connected by a network 608. The system 604 includes software operations or routines. The users 602 can interact with the system 604 in a number of ways, such as over one or more networks 608. One or more servers 606 accessible through the network(s) 608 can host system 604. The system 604 has access to one or more data stores 610. The one or more data stores 610 may include first data 612 as well as second data 614. It should be understood that the system 604 could also be provided on a stand-alone computer for access by a user.

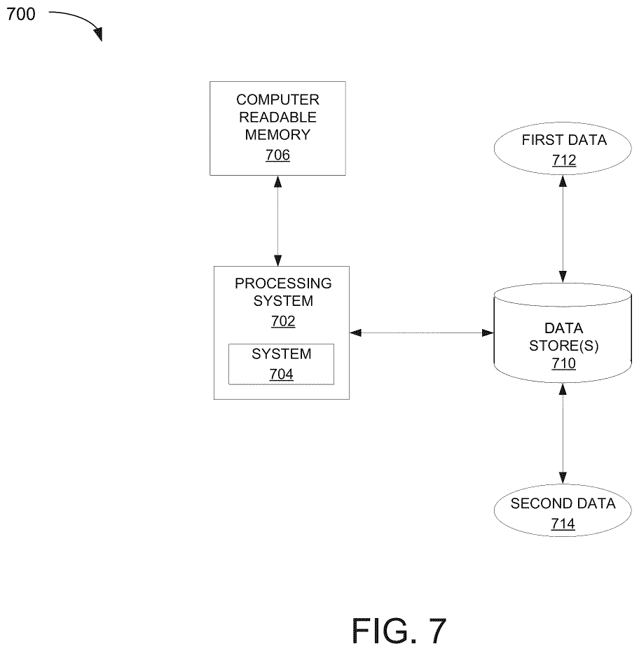

FIGS. 7, 8, and 9 depict example systems for use in implementing a system. For example, FIG. 7 is a block diagram that illustrates an example architecture 700 for the automation of low-level test creation for safety-critical embedded software, in accordance with the present disclosure. The architecture 700 includes a standalone computer architecture in which a processing system 702, e.g., one or more computer processors, includes a system 704 being executed on it. The processing system 702 has access to a non-transitory computer-readable memory 706 in addition to one or more data stores 710. The one or more data stores 710 may include first data 712 as well as second data 714.

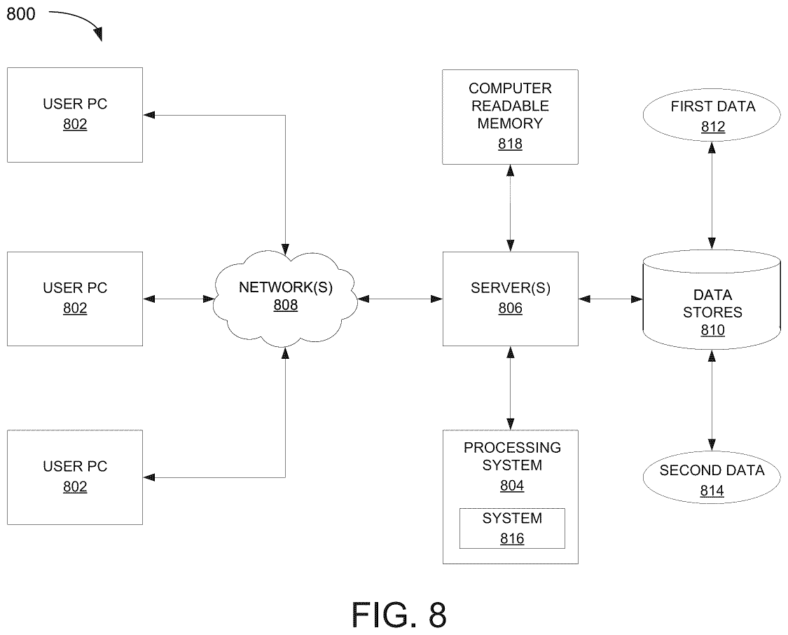

FIG. 8 is a block diagram that illustrates an example architecture 800 for the automation of low-level test creation for safety-critical embedded software, in accordance with the present disclosure. One or more user PCs 802 access one or more servers 806 running a system 816 on a processing system 804 via one or more networks 808. The one or more servers 806 may access a non-transitory computer readable memory 818 as well as one or more data stores 810. The one or more data stores 810 may include first data 812 as well as second data 814.

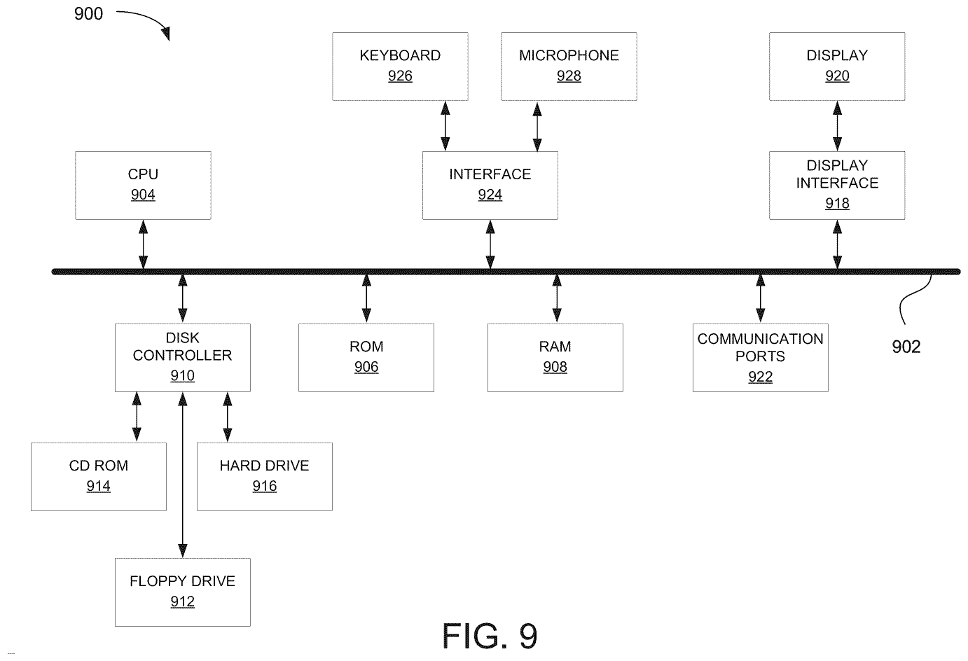

FIG. 9 is a block diagram of an example computing device 900 that may perform one or more of the operations described herein, in accordance with the present disclosure. Example computing device 900 may be used to include and/or implement the program instructions of the present disclosure. A bus 902 may serve as the information highway interconnecting the other illustrated components of the hardware. A CPU (central processing unit, e.g., one or more computer processors) 904, may perform calculations and logic operations required to execute a program. A non-transitory computer-readable storage medium, such as read-only memory (ROM) 906 and random-access memory (RAM) 908, may be in communication with the CPU 904 and may include one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 910 interface may connect one or more optional disk drives to the system bus 902. These disk drives may be external or internal floppy disk drives 912, external or internal CD-ROM, CD-R, CD-RW or DVD drives 914, or external or internal hard drives 916. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 910, the ROM 906 and/or the RAM 908. Preferably, the processor 904 may access each component as required.

A display interface 918 may permit information from the bus 902 to be displayed on a display 920 in audio, graphic, or alphanumeric format. Communication with external devices may optionally occur using various communication ports 922.

In addition to the standard computer-type components, the hardware may also include data input devices, such as a keyboard 926, or other input device 928, such as a microphone, remote control, pointer, mouse, touchscreen and/or joystick. These data input devices may be connected to the system bus 902 by way of an interface 924

This written description describes exemplary embodiments of the invention, but other variations fall within scope of the disclosure. For example, the systems and methods may include and utilize data signals conveyed via networks, e.g., local area network, wide area network, internet, combinations thereof, etc., fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data, e.g., associations, mappings, data input, data output, intermediate data results, final data results, etc., may be stored and implemented in one or more different types of computer-implemented data stores, such as different types of storage devices and programming constructs, e.g., RAM, ROM, flash memory, flat files, databases, programming data structures, programming variables, IF-THEN (or similar type) statement constructs, etc. It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object, as in an object-oriented paradigm, or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A method for automating creation and execution of low-level test cases for safety-critical applications, comprising:
creating a set of low-level test cases for a software design model associated with a set of high-level test cases by using a non-qualified test case creation tool and a qualified model coverage analysis tool;
verifying a coverage of low-level requirements for the software model by the set of low-level test cases with respect to coverage criteria;
generating source code preserving the coverage using a qualified code generator; and
executing a set of high-level test cases and the set of low-level test cases for the software design model on a target architecture based on the source code.

2. The method of claim 1, wherein the qualified code generator preserves a set of modified condition/decision coverage (MC/DC) properties from the software model.

3. The method of claim 1, wherein the set of low-level test cases includes a set of low-level test inputs generated by a non-qualified tool.

4. The method of claim 1, wherein the qualified model coverage analysis tool identifies a set of MC/DC gaps based on the set of high-level test cases.

5. The method of claim 4, wherein the qualified model coverage analysis tool indicates each MC/DC gap of the set of MC/DC gaps is covered by at least one low-level test case of the set of low-level test cases.

6. The method of claim 5, wherein verifying comprises comparing the at least one of the set of low-level test cases with the respective MC/DC gap of the set of MC/DC gaps.

7. The method of claim 5, wherein verifying comprises:
identifying, for each generated low-level test case of the set of low-level test cases, a coverage contribution, the coverage contribution includes coverage of the MC/DC gap or an equivalence class coverage gap associated with the generated low-level test case.

8. A system for automating creation and execution of low-level test cases for safety-critical applications, comprising:
a memory; and
a processor, operatively coupled to the memory, to:
create a set of low-level test cases for a software design model associated with a set of high-level test cases by using a non-qualified test case creation tool and a qualified model coverage analysis tool;
verify a coverage of low-level requirements for the software model by the set of low-level test cases with respect to coverage criteria;
generate source code preserving the coverage using a qualified code generator; and
execute a set of high-level test cases and the set of low-level test cases for the software design model on a target architecture based on the source code.

9. The system of claim 8, wherein the qualified code generator is further to preserve a set of modified condition/decision coverage (MC/DC) properties from the software model.

10. The system of claim 8, wherein the set of low-level test cases includes a set of low-level test inputs generated by a non-qualified tool.

11. The system of claim 8, wherein the qualified model coverage analysis tool is further to identify a set of MC/DC gaps based on the set of high-level test cases.

12. The system of claim 11, wherein the qualified model coverage analysis tool is further to indicate each MC/DC gap of the set of MC/DC gaps is covered by at least one low-level test case of the set of low-level test cases.

13. The system of claim 12, wherein to verify is further to compare the at least one of the set of low-level test cases with the respective MC/DC gap of the set of MC/DC gaps.

14. The system of claim 12, wherein to verify is further to:
identify, for each generated low-level test case of the set of low-level test cases, a coverage contribution, the coverage contribution includes coverage of the MC/DC gap or an equivalence class coverage gap associated with the generated low-level test case.

15. A non-transitory computer-readable storage medium including instructions that, when executed by a processing device, cause the processing device to:
create a set of low-level test cases for a software design model associated with a set of high-level test cases by using a non-qualified test case creation tool and a qualified model coverage analysis tool;
verify a coverage of low-level requirements for the software model by the set of low-level test cases with respect to coverage criteria;
generate source code preserving the coverage using a qualified code generator; and
execute a set of high-level test cases and the set of low-level test cases for the software design model on a target architecture based on the source code.

16. The non-transitory computer-readable storage medium of claim 15, wherein the qualified code generator is further to preserve a set of modified condition/decision coverage (MC/DC) properties from the software model.

17. The non-transitory computer-readable storage medium of claim 15, wherein the set of low-level test cases includes a set of low-level test inputs generated by a non-qualified tool.

18. The non-transitory computer-readable storage medium of claim 15, wherein the qualified model coverage analysis tool is further to identify a set of MC/DC gaps based on the set of high-level test cases.

19. The non-transitory computer-readable storage medium of claim 18, wherein the qualified model coverage analysis tool is further to indicate each MC/DC gap of the set of MC/DC gaps is resolved by at least one low-level test case of the set of low-level test cases.

20. The non-transitory computer-readable storage medium of claim 19, wherein to verify is further to compare the at least one low-level test case of the set of low-level test cases with the respective MC/DC gap of the set of MC/DC gaps.
